(19) United States
(12) Patent Application Publication
(10) Pub. No.: US 2007/0100852 A1
(43) Pub. Date: May 3, 2007

(54) File system management for integrated NOR and NAND flash memory

(76) Inventors: Jeffrey Wang, Minhang District (CN); Suresh Nagarajan, Mather, CA (US); John Rudelic, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/266,866

(22) Filed: Nov. 3, 2005

(51) Int. Cl. G06F 7/00

(52) U.S. Cl. 707/100

(57) ABSTRACT

A file management system for utilizing both NOR and NAND flash memory technology in a system is disclosed. Control structures are stored within NOR flash memory blocks. Data structures are stored within NAND flash memory blocks.

### BACKGROUND

The present invention relates to flash memory devices and more specifically to the integration of NOR and NAND flash memory.

NOR and NAND flash technology are quite different from one another. Each technology has advantages and disadvantages. For example, NOR flash reads have a fast initial access, while NAND flash has much slower initial access. Conversely, NOR flash is slow for program and erase operations when compared to NAND. Table 1, below, illustrates the major differences between NOR and NAND flash technology.

TABLE 1

| | NOR Flash | NAND Flash |
|---|---|---|
| Bit Twiddle | Yes | Very limited times on each |
| Ability | | buffer size (512 Bytes) |
| Execute In Place | Yes | No |
| (XIP) Ability | | |
| Read Speed | Fast initial access | Slow initial access, fast |
| | (100× better), fast | sequential access |
| | sequential access | |
| Write Speed | Slow program and | Fast program (10× better) |
| | erase | and erase (100× better) |
| Reliability | High | Low, need ECC support, has |
| | | bad blocks |

Because NOR and NAND flash memory have different characteristics, each type is suitable for different applications. However, using NOR and NAND flash together in the same system may allow a user to take advantages of the benefits of both types of flash, as well as mitigate the constraints of both.

### BRIEF DESCRIPTION OF THE DRAWINGS

A better understanding of the present invention can be obtained from the following detailed description in conjunction with the following drawings, in which:

FIG. 1 is an illustration of a block diagram illustrating file system storage in NOR and NAND flash memory devices.

FIG. 2 is a flow diagram illustrating file writing in a device using both NOR and NAND flash memory.

FIG. 3 is a flow diagram illustrating file system initialization for a device using both NOR and NAND flash memory.

FIG. 4 is a chart illustrating a comparison of write performance for NOR and NOR+NAND devices.

FIG. 5 is a block diagram illustrating a system using both NOR and NAND flash memory devices.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

Embodiments of the present invention concern flash memory devices, and more specifically, a file management system for utilizing both NOR and NAND flash memory technology.

A typical flash file system for a flash device includes user data as well as various control structures which are used to identify and link user data. For example, one user data file may be stored in multiple fragments, rather than in one contiguous portion of memory. Control structures, such as a link table may be used to link together the multiple fragments of the user file and identify which file each fragment belongs to. Other control structures may also be stored in flash to help manage the file system. These control structures may include, but are not limited to a directory infrastructure, power loss recovery structures, and others.

User data files and control structures have different operating requirements, as illustrated in Table 2, below.

TABLE 2

| Requirements | Control Structures | User Data |
|---|---|---|
| Bit Twiddle | Need, very useful for | No needed |
| Ability | manipulating file system | |
| Read Speed | Need fast initial access | Need fast sequential |
| | due to more jumps across | access speed, the |
| | different location, | initial access speed |
| | sequential access speed | is not critical |
| | is not critical | |
| Write Speed | Not critical, contribute | Critical, contribute |
| | less on system | more on system |
| Reliability | High, responsible to set | Low, may be critical |
| | up file system and link | for small parameter, |
| | user data | but is not critical |
| | | for large file (multi- |
| | | media file) |
| Occupied Space | Small, <10% of entire | Large, >90% of entire |
| | space | space |

A comparison between Table 1 and Table 2 illustrates that control structures are well suited to being stored in NOR flash memory, while user data is well suited to being stored in NAND flash memory. By separating the control structures and user data files in NOR and NAND flash memory, respectively, both can be manipulated with maximum efficiency and system performance may improve significantly.

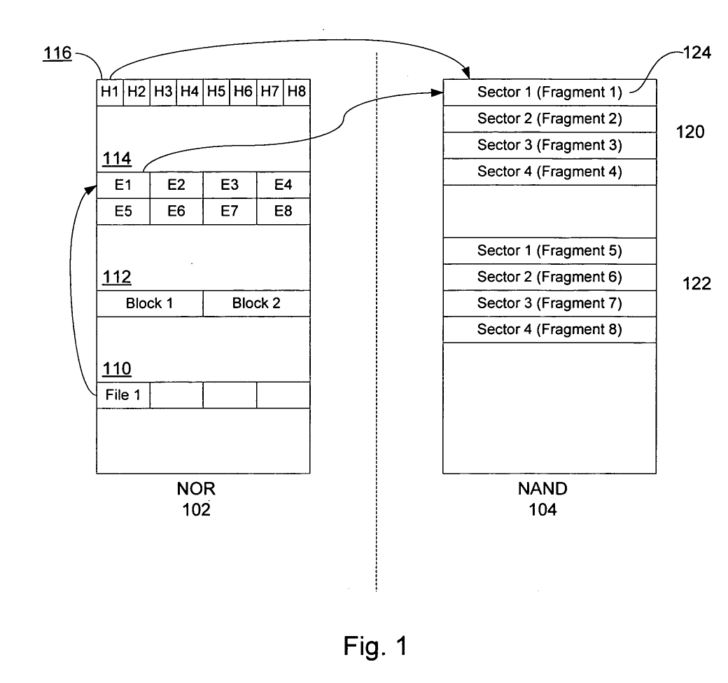

FIG. 1 illustrates an example file system storage layout using both NOR and NAND flash memory according to one embodiment. NOR flash memory (102) is used to store flash control structures, while NAND flash memory (104) is used to store user data. In one embodiment, the file system has two storage modes: control mode and object mode. Control mode may be used to access and manipulate control structures, while object mode may be used to access and manipulate user data.

Flash control structures stored in the NOR flash memory (102) may include, but are not limited to, a file directory (110), block information (112), a file link table (114) and sector headers (116).

User data, such as a file (120), is stored in blocks (120, 122) within the NAND flash memory (104). The user data may be split into fragments (122). Each fragment (122) may be stored in an individual sector within a NAND block.

According to one embodiment, the file system operates as follows. The file directory (110) includes a list of each user data file stored in the NAND flash memory. Each file listed in the file directory (110) (e.g. File 1) is associated with a file like table (114). The file link table (114) contains multiple entries, or link fragments (E1, E2, . . . E8). The entries in the file link table (114) each correspond to a fragment of a user data file stored in the NAND flash memory (104).

For example, for a user file, File 1, having 8 fragments, the file system may work as follows. The file directory (110) in NOR flash (102) lists File 1 as a file which is stored in NAND flash (104). File 1 is associated with a file link table (114). Each entry in the file link table (114) links to a fragment of the user file stored in NAND flash (104): E1 links to fragment 1 in sector 1, E2 links to fragment 2 in sector 2, etc.

Thus, a user file stored in fragments in NAND flash memory may be accessed by first accessing the file directory in NOR flash memory. The file directory points to the file link table for the user file. The file link table is also stored in NOR flash memory. The file link table links to each fragment of the file in NAND flash memory, thereby allowing read or write access to the entire user file.

The control structures stored in NOR flash memory may also include additional information related to the user data, including, but not limited to block information (112) and sector headers (116).

The block information control structure (112) may store specific information related to each block of the NAND flash memory (120, 122). For example, the block information control structure may include information related to the status of a NAND flash block or other information about the block.

The sector header information control structure (116) may contain fragment state information for each fragment stored in a sector within a NAND block. The sector header information may also include power loss recovery (PLR) information for each sector. For example, each sector header (H1, H2, . . . , H8) may contain one or more power loss recovery bits. These bits may be used to determine the state of a given sector when a power loss occurs.

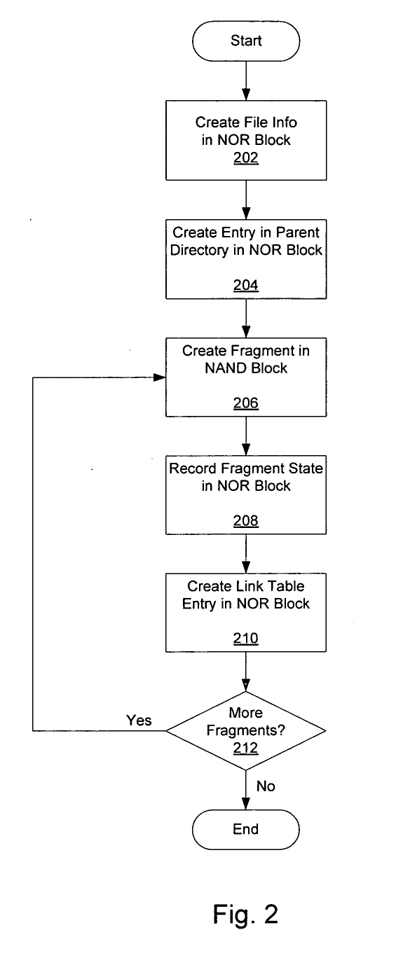

FIG. 2 is a flow diagram illustrating a write operation according to one embodiment. A write operation may include a write of a new user data file, or an update to an existing user data file. Upon initiation of a write operation, file information for the user data file is created in a NOR flash memory block (202). The file information is one type of control structure that may be stored in the NOR flash, and may include information such as, but not limited to, the file name, date, and file size.

A corresponding entry for the file is created in the NOR block file directory (204). The file directory entry will ultimately link to the file link table, allowing access to the data file.

After the file directory entry has been created, a fragment of the user data file may be written to the NAND block (206). In one embodiment, the fragment may be written to a sector within the NAND block.

The fragment state is recorded in the NOR block (208). The fragment state may be written to a sector header control structure within the NOR block. In one embodiment, a fragment state bit in the sector header may be set when the fragment write is initiated, and a second fragment state bit may be set when the fragment write has completed. In this manner, power loss recovery (PLR) information may be tracked in the NOR control structure.

A link table entry is also created in the NOR block for the user data file (210). The link table entry links each of the file fragments together, allowing access of the user data file through the file directory.

If there are additional fragments in the user file (212), each of these fragments will be written to the NAND block (206), a fragment state will be recorded in the NOR block, and a link table entry will be created in the NOR block.

The order of operations during a file write is not critical. For example, creation of file information in the NOR block (202) and creation of an entry in the file directory in the NOR block (204) may occur in a different order than shown. Furthermore, writing of the fragment to NAND memory, recording of the fragment state in NOR memory, and creation of the link table entry for the fragment may occur in any order.

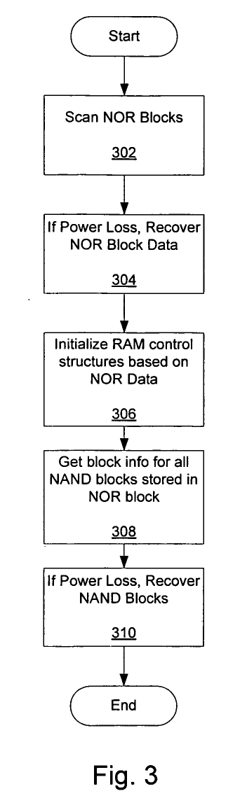

FIG. 3 is a flow diagram illustrating file system initialization according to one embodiment. Upon initialization of the file system, the NOR blocks within a NOR flash memory device are scanned to determine whether a power loss has occurred (302). In one embodiment, each NOR block may have power loss recovery (PLR) bits associated with the block to indicate if the NOR block was being written when power was lost.

If the NOR block scan (302) indicates that a power loss has occurred, data recovery for the NOR blocks is initiated to recover NOR block data (304).

Next, random access memory (RAM) control structures may be setup or initialized based on the data in the NOR blocks (306). The RAM control structures may be used to organize a subset of the flash control information in RAM. Reordering some of the flash control information in RAM helps eliminate scanning the flash for the information, thus allowing faster access to the control information.

The block information for each NAND block may also be accessed during file system initialization (308). The header information for each sector within the NAND block may be accessed instead of, or in addition to the block information. The block information and header information is stored in the NOR flash memory device. Either the block information structure or the header information structure may contain data regarding whether a power loss has occurred.

If it is determined that a power loss has occurred, the data within the NAND blocks must be recovered (310).

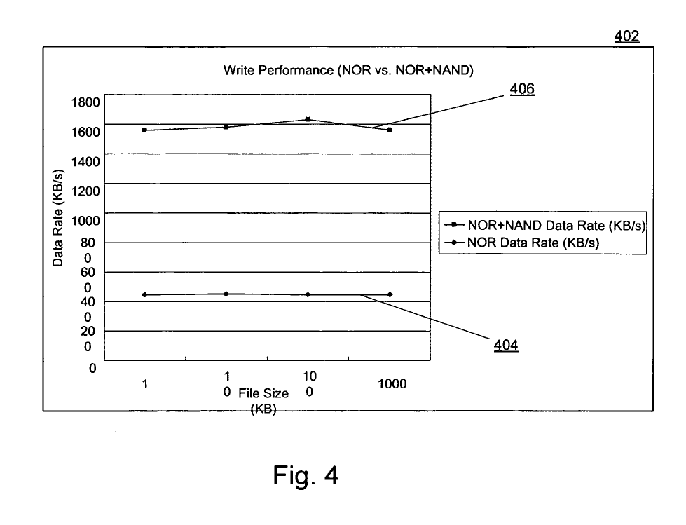

FIG. 4 is a chart (402) which illustrates an estimated write performance advantage that may be achieved according to embodiments of the present invention. By storing flash control structures in NOR flash memory separately from user data in NAND flash memory, it is possible to utilize the benefits of both types of memory. For example, storage of control structures in NAND allows for bit alterability, fast read, and high reliability. Storage of user data in NOR flash memory allows fast write/erase of the control structures and high densities.

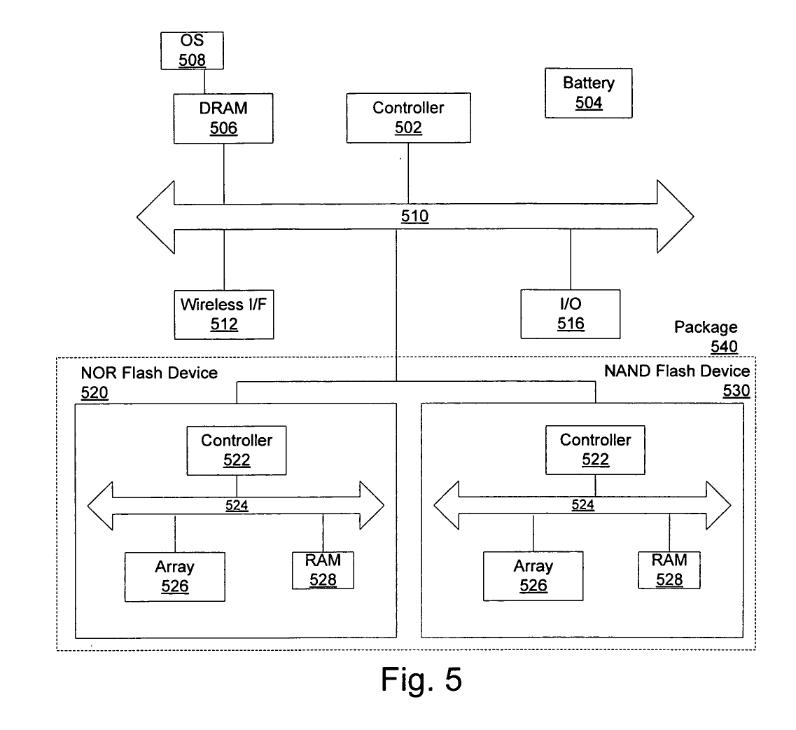

FIG. 5 is a block diagram of a system according to one embodiment of the present invention. The system may include a bus (510) which communicates with a controller (502). The controller (502) may be a microcontroller, one or more microprocessors, a digital signal processor (DSP), or another type of controller. The system may be powered by a battery (504) or may be powered with another type of power supply.

System memory or dynamic random access memory (DRAM) (506) may be coupled to the bus (510). The DRAM (506) may store an operating system (OS) (508) after system initialization.

A variety of input/output (I/O) devices (516) may be coupled to the bus (510). The I/O devices may include items such as a display, keyboard, mouse, touch screen, or other I/O devices. A wireless interface (512) may also be coupled to the bus (510). The wireless interface (512) may enable cellular or other wireless communication between the system and other devices. In one embodiment, the wireless interface (512) may include a dipole antenna.

The system also includes a NOR flash memory device (520) and a NAND flash memory device (530). The flash memory devices may be built into the system, or may be part of a removable storage medium, such as a card form factor, that may be inserted into an optional flash card interface. In one embodiment, the NOR flash memory device (520) and the NAND flash memory device (530) may be combined in a single package (540). For example, the two types of flash devices may be stacked together in a package.

Each flash memory device (520, 530) may include a controller (522) coupled by a bus (524) to the flash array (526) and a small random access memory (RAM) (528).

The NOR flash memory device (520) may store control structures in blocks within the flash array. The control structures that may be stored in the NOR flash memory include, but are not limited to a file directory, block information, a file link table and sector headers, as described above in conjunction with FIG. 1.

The NAND flash memory device (530) may store user data in blocks within the flash array. For example, a music file or other type of data file may be stored in NAND flash memory. The user data may be split into fragments, and each fragment may be stored in a separate sector within a NAND block, as described above in conjunction with FIG. 1.

The methods set forth above may be implemented via instructions stored on a machine-accessible medium which are executed by a processor. The instructions may be implemented in many different ways, utilizing any programming code stored on any machine-accessible medium. A machine-accessible medium includes any mechanism that provides (i.e., stores and/or transmits) information in a form readable by a machine, such as a computer. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Thus, a method, system, and machine accessible medium for integrated NOR and NAND flash memory file system management are disclosed. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
storing control structures in a NOR flash memory device;
storing user data in a NAND flash memory device; and
maintaining a table in the NOR flash memory device to manage the user data.

2. The method of claim 1, wherein maintaining a table comprises maintaining a link table.

3. The method of claim 1, wherein storing control structures comprises storing a directory infrastructure.

4. The method of claim 3, wherein storing control structures further comprises storing power loss recovery information.

5. The method of claim 1, wherein the user data is stored in multiple fragments.

6. The method of claim 5, wherein storing user data comprises creating a file entry in the NOR flash memory device, creating a corresponding entry in a file directory in the NOR flash memory device, creating a fragment in the NAND flash memory device, recording a state for the fragment in the NOR flash memory device, and creating a link table entry in the NOR flash memory device.

7. A system comprising:
a bus;
a processor coupled to the bus;
a wireless interface coupled to the bus; and
a NOR flash memory device coupled to the bus, the NOR flash memory device to store control structures; and
a NAND flash memory device coupled to the NOR flash memory device, the NAND flash device to store user data.

8. The system of claim 7, wherein the NAND flash memory device is further coupled to the bus.

9. The system of claim 7, wherein the NAND flash memory device and the NOR flash memory device are in a single package.

10. An article of manufacture comprising a machine-accessible medium having stored thereon instructions which, when executed by a machine, cause the machine to:
create file information for a user data file in a NOR flash memory block;
create an entry for the user data file in a file directory in the NOR flash memory block;
write a fragment of the user data file to a sector within a NAND flash memory block;
record state information for the fragment of the user data file in the NOR flash memory block; and
create a link table entry for the fragment of the user data file in the NOR flash memory block.

11. The article of manufacture of claim 10, wherein file information includes at least a file name, a date, and a file size.

12. The article of manufacture of claim 10, wherein state information includes power loss recovery (PLR) information.

13. An article of manufacture comprising a machine-accessible medium having stored thereon instructions which, when executed by a machine, cause the machine to:
scan NOR flash memory blocks;
initialize RAM control structures with NOR block data; and
access block information for NAND flash memory blocks.

14. The article of manufacture of claim 13, wherein the instructions, when executed by a machine, further cause the machine to recover data in the NOR flash memory blocks.

15. The article of manufacture of claim 14, wherein the instructions, when executed by a machine, further cause the machine to recover data in the NAND flash memory blocks.
